(19) United States
(12) Patent Application Publication
(10) Pub. No.: US 2006/0102038 A1
(43) Pub. Date: May 18, 2006

(54) Method for the correction of variations in the amount of ink applied to the printed image occurring in the printing process

(75) Inventors: Martin Kruempelmann, Lengerich (DE); Dietmar Poetter, Westerkappeln (DE)

Correspondence Address: JACOBSON HOLMAN PLLC, 400 SEVENTH STREET N.W., SUITE 600, WASHINGTON, DC, 20004, US

(73) Assignee: Windmoeller & Hoelscher K G

(21) Appl. No.: 10/541,849

(22) PCT Filed: Jan. 15, 2004
(86) PCT No.: PCT/EP04/00416

§ 371 Date: Jul. 12, 2005

(30) Foreign Application Priority Data
Jan. 24, 2003 (DE) 103 02 747.5

(51) Int. Cl. B41F 33/00

(52) U.S. Cl. 101/484

(57) ABSTRACT

A process for adjusting the print image of a rotating machine is described. The rotation printing machine is equipped with in transfer rollers (F, K) and actuators assigned to them, with which it is possible to change the position (x) of the rollers (F, K). The new and inventive element of this process is that during the printing operation, at least one camera records the intensity of the light reflected from the printed material. The camera also feeds the recorded measured values to a control and regulation unit that compares the recorded measured values with set values and generates corrective signals for the actuator of at least one part of the rollers involved in the printing process. Based on the corrective signals, the actuator of the relative position of the roller assigned to it is changed till the measured values once again lie within a tolerance range.

The invention relates to a process according to the generic term of claim 1. Such a process is known from DE 101 45 927. This patent application describes the process of automatically adjusting the positions of the rollers involved in the printing process following a job changeover. Furthermore, it contains the detailed description of a printing machine that has the characteristics of the generic term of claim 4 and therefore enables the execution of said process. This patent application does not contain an in-depth description and graphic illustration of said device and/or said process. Hence, the corresponding passages of DE 101 45 927 must be consulted for the intelligibility of the present application and are herewith included in this application.

The application of the afore-mentioned process shortens changeover time considerably. Furthermore, said process is used to adjust the rollers involved in the printing process to one another so as to produce print images of high reproduction quality. Here the contact pressure between the rollers involved in the printing process is maintained at the lowest level possible.

Surprisingly, however, in case of high printing speeds, there is an incidence of variations in the ink intensity of the print image transferred that are attributed to variations in the ink quantity transferred during the printing process. As a rule, the ink intensity reduces. According to the opinion of the patent applicant, the reasons for this surprising effect lie in the variations of the effective radius of the rollers involved in the printing process and in the separation behavior of the printing inks. The former effect is specified in the present description.

Therefore the task of the present invention is to minimize these variations.

According to the invention, this task is solved by the features specified in the characteristics of claim 1.

For the purpose of understanding the scope of the present invention, it is important that the “set values” defined in claims 1 and 4 can be determined in the form described in DE 101 45 925, i.e. they can be derived in a “digital set form” of the printed image that is stored in a storage device.

However, “set values” as defined in this invention can also be determined by evaluating the characteristic progression of the intensity of the reflected light. This characteristic progression develops while engaging the rollers involved in the printing process. This characteristic progression and its evaluation for adjusting the roller positions are also described in DE 101 45 925. The set values defined in the present patent application relate to a light intensity value that is recorded by the camera at a definite point in the characteristic progression of the light intensity. This light intensity value, which is usually derived during the proof print and/or the number of light intensity values forming the composition of the print image or its sections, can be stored. It can subsequently be output from the storage device during the printing process as the set values defined in this patent application and used for regulatory purposes. However, a set value of the light intensity can also be a light intensity value that is recorded repeatedly at a definite point in the characteristic progression of the light intensity during the printing operation if necessary.

The wording, “at least one sensor—for instance, a camera—records the intensity of light experiencing an interaction with the printed material” mentioned in the characteristics of claim 1 includes explicitly all sensors that are suited for recording light intensity. Most of these sensors known from prior art work on the basis of photoelectric effect wherein in recent times preferably semiconductors are used as optically active materials. Semiconductors are also a component of electronic cameras. In this context, CCD cameras (CCD=Charge Coupled Device) are included among the sensor systems that are used preferably.

It is particularly advantageous if the roller position is controlled in addition to being regulated in accordance with the invention. For this purpose the position of the print rollers can be controlled merely as the function of the speed, preferably before using the regulation in accordance with the invention. Empirical values form the basis of this control that are stored, for instance, in the form of a calibration table in which a position value is assigned to a speed value. Of course positions can be assigned to printing speeds even with the help of appropriately adjusted algorithms or derivatives. The present description also provides an example for this subject area.

Advantageous processes in which at least one sensor records the intensity of the light experiencing an interaction with the printed material are also processes measuring the transmission of light through the printing substrate. For this purpose, the intensity of the light falling on the printing substrate should be known so that the absorption of the printing substrate results from the difference between the incident light and the transmitted light. It is therefore advantageous to use a light source that provides the incident light of known intensity. This radiation can take place under standard test conditions. This can be allowed for by a box that is shielded from light and that protects the substrate at the place of measurement, for example, as well as the light source and the sensor from ambient light.

Even in these embodiments of the invention, the intensity of the light experiencing an interaction with the printed material is recorded. In this connection, it is immaterial whether this interaction is in the form of a transmission and/or absorption, a reflection, refraction or any other interaction process between light and print image.

Additional embodiments of the invention are explained in the present description and in the claims. The individual figures illustrate:

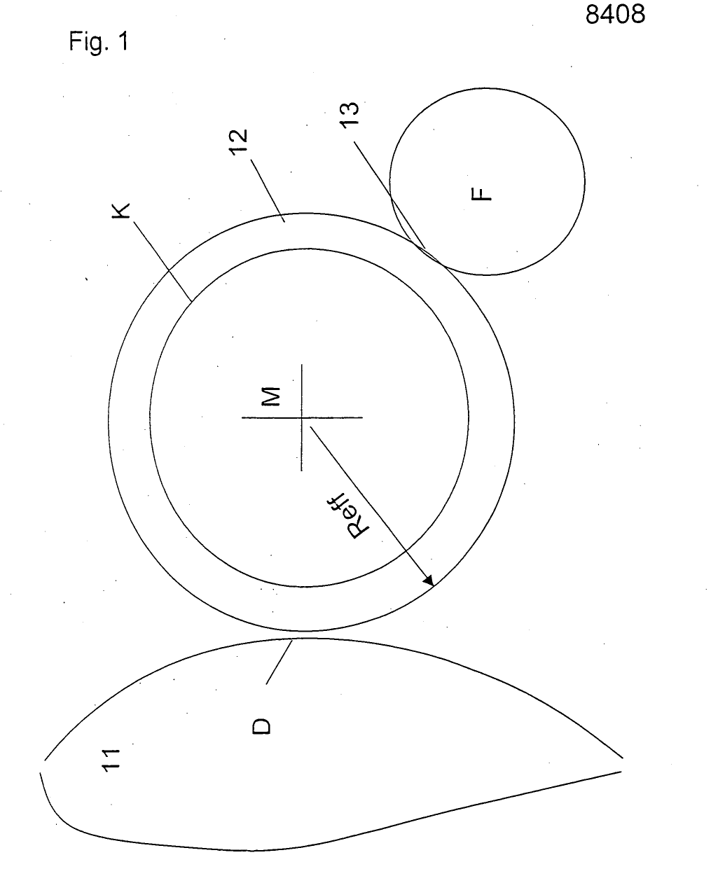

FIG. 1 an illustration of the term “effective radius.”

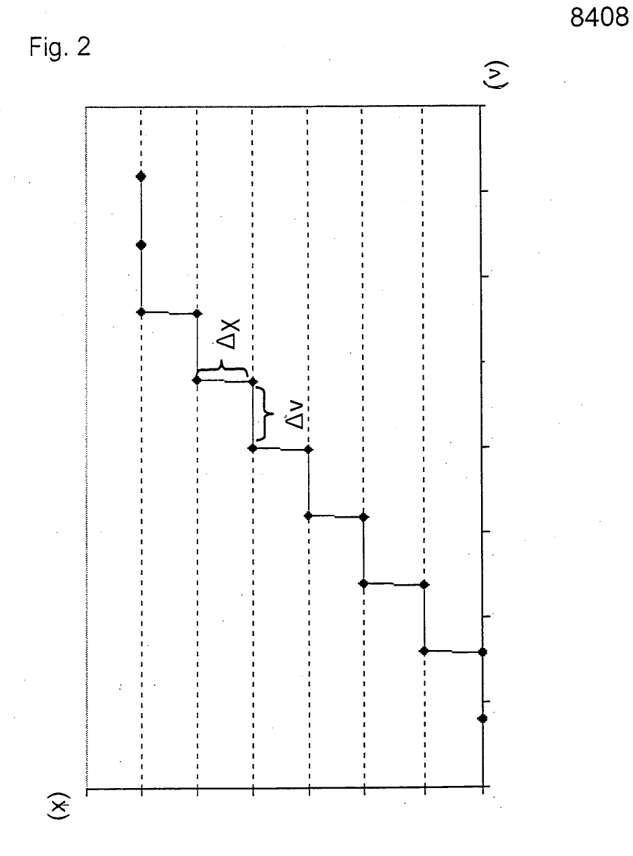

FIG. 2 an example for an operation based on which a roller position is controlled in relation to the printing speed.

FIG. 1 illustrates the position of the plate roller K in an example of an inking unit comprising the plate roller K during the printing process. The plate roller K and other flexible materials involved in the printing process such as the rubber coating (not illustrated in the figure) that can also be present on the impression roller in other flexographic printing machines and the printing substrate (also not illustrated) are exposed to strong forces in the printing process. Thus the plate 12 is squashed along the pressure line D between the impression roller 11 and the plate roller K. A similar process takes place on the pressure line 13 between the plate roller K and the inking roller F. During a fast rotation of the roller K around its rotation axis M it is possible that the deformation, particularly of the plate, on the aforementioned pressure line K and 13 is no longer compensated for by the reset forces of the squeezed material 11, 12, K before the squeezed material reaches the pressure line D again. Therefore in this case, the effective radius R_{eff}, that indicates the distance between the outer circumference of the plate and the rotation axis M immediately before the pressure line D is reached again, falls. However, this effective radius R_{eff} is decisive for the quality of the printing process. In the case described above of the shrinkage of the effective radius, the physical pressure on the pressure line D falls, adversely affecting the ink transfer on the printing substrate. In this case the operator of the printing machine or the machine control system of a flexographic printing machine ought to place the plate roller more strongly against the impression roller 11.

However, in view of the high centrifugal forces, the use of some materials can lead to an increase in the effective radius R_{eff} which results in an increase of the physical pressure on the pressure line D. In this case the plate roller K is pulled out somewhat further from the impression roller 11. Both processes are summarized for the purposes of this application by the technical term “dynamic infeed.” As has been mentioned already, even the ink separation behavior as a function of the printing speed can change and thus influence the ink transfer.

FIG. 2 illustrates an operation that forms the basis of the correction of the position of a roller x in relation to the speed v. The operation has a staircase-like form, i.e. an increase of printing speed after certain speed intervals Δv leads to infeed processes by Δx. In the case of a flexographic printing machine, this usually means that the plate roller is moved further in the direction of the impression roller in case of an increase in the speed. Then, as a rule, even an additional infeed of the anilox roller on the plate cylinder ought to be necessary. The illustrated devices and processes can be used particularly advantageously in flexographic printing and intaglio printing.

The illustrated option of the speed-dependent control of the roller positions can be advantageously combined with the process according to the invention if the speed-dependent process of control is executed first followed by the regulation process with the help of the evaluation of the print image.

As has been mentioned already, even other operations, algorithms or calibration tables can be consulted for the speed-dependent control. In this connection, even linear or asymptotical dependencies between printing speed (v) and roller position (x) are also possible.

List of reference symbols

| | |
|---|---|
| 11 | Impression cylinder |
| 12 | Plate |
| 13 | Anilox roller-plate roller pressure line |
| K | Plate roller |
| D | Pressure line of the plate roller on the impression cylinder |
| F | Inking roller |
| M | Rotation axis |
| R_{eff} | Effective radius of a plate roller |
| x | Position of a roller |
| v | Printing speed |
| Δv | Speed interval |
| Δx | Infeed process |

1. Process for adjusting the print image of a rotation printing machine,
comprising ink transfer rollers (F, K) and actuators assigned to them,
with which it is possible to change the position of the rollers (F, K), and in which
at least one sensor—for instance, a camera—records the intensity of light experiencing an interaction with the printed material and
that the recorded measured values are fed to a control and regulation unit,
that compares the recorded measured values with set values and
that generates corrective signals for the actuator of at least one part of the rollers involved in the printing process
based on which the actuator changes the relative position (x) of the roller assigned to it until the measured values once again lie within a tolerance range
characterized in that
during the printing process at least one sensor records measurements of the intensity of light experiencing an interaction with the printed material,
during the printing operation the measured values are assigned to the ink transferred in at least one inking unit,
during the printing operation the control and regulation unit generates corrective signals for the actuator of at least one part of the rollers (F, K) of the respective inking unit involved in the printing process,
so that the variations in the ink quantity transferred onto a unit of area of the print image remain within a set range.

2. Process according to claim 1 characterized in that in case of changes in the printing speed (v), the control and regulation unit generates additional corrective signals based on which the actuators adjust the roller positions in relation to the printing speed (v).

3. Process according to claim 2, characterized in that in case of changes in the printing speed (v), the control and regulation unit generates additional corrective signals based on calibration tables or algorithms that are stored in a storage device.

4. Process according to claim 1, characterized in that the sensor records the intensity of light that is penetrated previously by the printed material.

5. Process according to claim 4, characterized in that at least one light source supplies light to the side of the printed material that is opposite to the sensor.

6. Rotation printing machine with the following features:
ink transfer rollers (F, K) and actuators assigned to them,
wherein it is possible, with at least one actuator, to change the relative position (x) of the roller assigned to it based on corrective signals of the control and regulation unit,
at least one sensor—for instance, a camera—for recording the intensity of light experiencing an interaction with the printed material,
a control and regulating unit comprising means to compare the recorded measured values with set values and with which it is possible to generate corrective signals for the actuator of at least one part of the rollers (F, K) involved in the printing process,
characterized in that
the control and regulating unit is provided with a program using which the measured values during the printing operation are assigned to the ink transferred in the inking unit and
that it is possible, with the control and regulation unit to generate corrective signals during the printing operation for the actuator of at least one part of the rollers of the respective inking unit involved in the printing process.

7. Device according to claim 6 characterized in that, at least one sensor with which it is possible to measure the light intensity in different spectral ranges.

8. Process according to claim 2, characterized in that the sensor records the intensity of light that is penetrated previously by the printed material.

9. Process according to claim 3, characterized in that the sensor records the intensity of light that is penetrated previously by the printed material.
